(19) United States
(12) Patent Application Publication
(10) Pub. No.: US 2023/0330448 A1
(43) Pub. Date: Oct. 19, 2023

(54) DE-MISTING SYSTEM FOR A MASK AND ASSOCIATED METHODS

(71) Applicant: AVOX SYSTEMS INC., Lancaster, NY (US)

(72) Inventor: Christopher Miller, Lancaster, NY (US)

(21) Appl. No.: 18/025,575

(22) PCT Filed: Oct. 14, 2021
(86) PCT No.: PCT/US2021/055048

§ 371 Date: Mar. 9, 2023

Related U.S. Application Data
(60) Provisional application No. 63/093,784, filed on Oct. 19, 2020.

(51) Int. Cl. A62B 9/00; A62B 18/02; A62B 18/10

(52) U.S. Cl. CPC A62B 9/003; A62B 18/02; A62B 18/10

(57) ABSTRACT

A de-misting system for goggles includes a supply connector, a de-mist tube, and a diffuser. The supply connector is connectable to a de-misting gas source, and the de-mist tube is in fluid communication with the supply connector. The diffuser is in fluid communication with the de-mist tube, and the diffuser may be coupled to an orifice of the goggles to supply a de-misting gas to an interior volume of the goggles.

### REFERENCE TO RELATED APPLICATION

This application claims the benefit of U.S. Provisional Patent Application No. 63/093,784, filed on Oct. 19, 2020, and entitled SYSTEM AND METHOD FOR RETROFITTING A DE-MIST DEVICE TO AN EXISTING MASK, the content of which is hereby incorporated by reference in its entirety.

### FIELD OF THE INVENTION

The field of the invention relates to mask systems that include goggles and masks, and more particularly to de-misting systems for mask systems.

### BACKGROUND

Mask and respiratory systems may generally include goggles and a mask, and such systems may be used in a variety of environments. Examples of mask systems include, but are not limited to, an oxygen mask, a smoke mask, a respirator, a chemical, biological, radiological, and nuclear (CBRN) respirator, a fire-fighting mask, a scuba system, a helmet optic, a corrective lens, or night-vision goggles. Existing mask systems rely on passive anti-fog systems and have a propensity to fog up and/or to accumulate condensation from an exhaled breath of the user on the lens of the goggles. Such fogging and/or condensation may be dangerous for the user as it will disrupt the ocular acuity of the lens, and a user may be unable to see through the lens and/or have blurred vision through the lens, potentially to a point where instruments or equipment readings, among other items, cannot be read or properly viewed. This can result in loss of situational awareness, dizziness, and/or the ability to perform critical activities. For example, a user on an aircraft may be unable to perform critical flight or crew activities if their mask is compromised due to fogging and/or condensation.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a de-misting system for goggles includes a supply connector connectable to a de-misting gas source, a de-mist tube in fluid communication with the supply connector, and a diffuser in fluid communication with the de-mist tube. In certain embodiments, the diffuser may couple to an orifice of the goggles to supply a de-misting gas to an interior volume of the goggles.

In various embodiments, the diffuser may couple to a harness point of the goggles. In some embodiments, the diffuser may supply the de-misting gas with a laminar flow across an interior surface of the goggles. In certain aspects, the de-misting system also includes a vent for exhausting the de-misting gas from the interior volume of the goggles. The vent may be coupled to a second orifice of the goggles. In some cases, the vent is coupled to a second harness point of the goggles opposite from a first harness point of the goggles. In certain embodiments, the vent includes a check valve.

In some embodiments, the diffuser includes a check valve. The de-mist tube may include a control valve for controlling a flow of the de-misting gas from the gas source to the diffuser. In various embodiments, the de-misting system also includes an intra-mask plug that may block an oral-nasal vent of the goggles. In certain aspects, the supply connector includes a tee connector with a main passage and a branch passage, and the de-mist tube may be attached to the branch passage of the supply connector.

According to certain embodiments, a mask system includes goggles with a lens defining an interior volume and an orifice providing access to the interior volume. The mask system also includes the de-misting system, and the diffuser may be coupled to the orifice of the goggles.

In some cases, the orifice is a first harness point, the goggles include a second harness point, and the de-misting system includes a vent coupled to the second harness point for exhausting the de-misting gas from the interior volume of the goggles. In some embodiments, the mask system includes a mask portion for receiving a breathing gas. The mask-system may include a breathing hose connected to the mask portion and configured to supply the breathing gas to the mask system, and the supply connector may be connected to the breathing hose such that the breathing gas is supplied to the diffuser and the goggles as the de-misting gas.

According to certain embodiments of the present invention, a mask system includes goggles with a lens defining an interior volume and an orifice providing access to the interior volume. The mask system also includes a de-misting system in fluid communication with the orifice. The de-misting system may supply a de-misting gas from a gas source to the interior volume of the goggles via the orifice.

In some embodiments, the de-misting system includes a supply connector, a diffuser attached to the orifice, and a de-mist tube connecting the supply connector with the diffuser. In various embodiments, the mask system also includes a mask portion and a breathing hose connected to the mask portion that supplies a breathing gas to the mask portion. The supply connector may be connected to the breathing hose such that at least some of the breathing gas is supplied to the interior volume as the de-misting gas. In certain embodiments, the mask system optionally is selected from the group consisting of an oxygen mask, a smoke mask, a respirator, a chemical, biological, radiological, and nuclear (CBRN) respirator, a fire-fighting mask, a scuba system, a helmet optic, a corrective lens, or night-vision goggles.

According to certain embodiments of the present invention, a method for attaching a de-misting system to existing goggles includes attaching a supply connector to a breathing hose, attaching a diffuser to a first harness point of the goggles, and attaching a de-mist tube to the supply connector and the diffuser.

### BRIEF DESCRIPTION OF THE DRAWINGS

FIG. 1 illustrates a mask system with a de-misting system according to certain embodiments of the present invention.

FIG. 2 illustrates a mask system with a de-misting system according to certain embodiments of the present invention.

FIG. 3 is another view of the mask system of FIG. 2.

FIG. 4 is another view of the mask system of FIG. 2.

FIG. 5 illustrates a supply connector of the de-misting system of FIG. 2.

FIG. 6 illustrates a user with the mask system of FIG. 2.

FIG. 7 is another view of the user with the mask system of FIG. 2.

FIG. 9 illustrates a portion of the mask system of FIG. 2.

FIG. 9 illustrates a portion of the mask system of FIG. 2.

FIG. 10 illustrates a portion of the mask system of FIG. 2.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down.” “top,” “bottom,” “left,” “right,” “front,” and “back.” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements.

Many masks, goggles, helmets, and other such devices (collectively referred to as “masks” and/or “goggles” in this disclosure) for use in aviation, among other industries, suffer from condensation issues such as fogging, misting. etc. that cause a reduction in visibility to the wearer but include no active systems for removing such condensation. However, in many cases, these existing masks have gone through extensive certification processes to be approved for use in their respective applications. Alteration of such systems to include a de-mist system may trigger additional certification testing, which would delay the use of such systems. Furthermore, requiring alteration of such masks may require skilled personnel and considerable training in order to effectuate the needed alterations.

The described embodiments of the invention provide de-misting systems for mask systems with goggles. Such de-misting systems may be provided natively with new goggles or as retrofit systems to existing goggles. While the de-misting systems are discussed herein for use with aircraft masks, they are by no means so limited. Rather, embodiments of the de-misting systems provided herein may be used natively or as a retrofit to any type of mask system for use in aviation, ground, or other applications as desired, including but not limited to an oxygen mask, a smoke mask, a respirator, a chemical, biological, radiological, and nuclear (CBRN) respirator, a fire-fighting mask, a scuba system, a helmet optic, a corrective lens, or night-vision goggles. The de-misting systems can be used in various applications as desired, including but not limited to military applications as well as commercial, business jet, and general aviation aircraft. It thus will be appreciated that in some embodiments, a mask system may only include goggles, and it need not include a mask portion. In one non-limiting example, the de-misting system may be a retrofit an oxygen mask and respirator. In various embodiments, the de-misting systems described herein may be used for retrofitting an existing mask without the need to alter the mask (e.g., without the need to cut holes, etc.), which would otherwise require a re-certification of the mask.

The de-misting systems described herein may include a de-mist tube that is a delivery tube or conduit that carries a de-misting gas from a gas source, such as a compressed gas source, gas delivery hose, etc., and directs the de-misting gas into the mask, respirator, or visor lens for the purpose of de-misting. In some embodiments, the de-misting gas may be available dry gas (e.g. oxygen, air, and/or other breathing gas and/or dry gas), and the de-misting systems may utilize such dry gas to remove and prevent accumulation of condensation and fogging of any oxygen mask, respirator, helmet visor, etc. As used herein, “de-misting” is intended herein to broadly include anti-fogging, de-misting, or any type of removal of condensation. In certain embodiments, such de-misting systems can be critical for any mask, respirator, or helmet system having optics requiring clear vision. In certain embodiments, the de-misting systems described herein may reduce or eliminate fogging or condensation on oxygen masks, respirators, helmet goggle lenses, and the like, such that the user is able to see clearly, read instruments or data, and perform critical flight, crew, and/or any other functions as desired while wearing the mask or respirator.

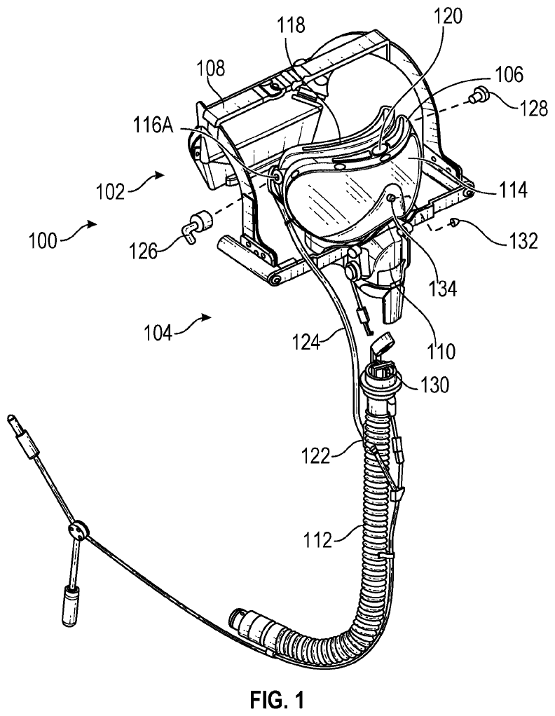

FIG. 1 illustrates a mask system 100 according to various embodiments. The mask system 100 generally includes a mask 102 and a de-misting system 104.

The mask 102 includes goggles 106, and may optionally include various other features or components as desired. In the embodiment illustrated, the mask 102 is the 358 Full-Face Oxygen Mask from Avox Systems; however, the mask 102 illustrated should not be considered limiting, and in other embodiments the de-misting system 104 may be provided with various other types of masks 102 having various configurations and/or features as desired. In the embodiment of FIG. 1, in addition to the goggles 106, the mask 102 includes a harness 10N for enabling rapid donning or removal of the mask 102 from a user, optionally with a single hand. The mask 102 also includes a mask portion 110 and a breathing hose 112 that may supply a breathing gas to the user when the mask 102 is worn. Optionally, the breathing hose 112 includes a flow regulator 130, including but not limited to a valve, for controlling the flow of a breathing gas to the mask portion 110 of the mask 102.

The goggles 106 include a lens 114 that defines an interior volume. As used herein, the “interior volume” is a portion of the goggles configured to cooperate with the wearer to form an enclosed volume. Optionally, the lens 114 may include a treatment or finish on an interior surface 146 (see FIG. of the lens 114 to reduce or eliminate condensation from forming on the lens 114. In one non-limiting example, the interior surface 146 of the lens 114 includes an anti-fog coating. In other embodiments, such treatments or finishes may be omitted.

In various embodiments, the goggles 106 include at least one existing orifice 116 that is engaged by the de-misting system 104, as discussed in detail below. In the embodiment of FIG. 1, the goggles 106 include two orifices 116 (only orifice 116A is visible in the view of FIG. 1, but another orifice is on the opposite side of the goggles 106 from orifice 116A). However, the number of orifices 116 should not be considered limiting on the disclosure. The existing orifices 116 may be various openings, apertures, etc. define in the goggles 106. In some embodiments, the orifices 116 are defined in the lens 114, although in other embodiments the orifices 116 may be defined on other portions of the goggles 106, such as a cover portion, frame, and/or otherwise as desired. In the embodiment illustrated, the orifices 116 are harness points on opposing sides of the goggles 106 and on a frame 118 of the goggles 106 that is proximate to a temple area of a user when worn. In these embodiments, the harness 108 may be affixed to the goggles 106 at the orifices 116 as desired, and when the harness 108 is not in used, the orifices 116 may be sealed with a removable plug or other device to maintain the enclosed interior volume within the goggles 106. In other embodiments, the de-misting system 104 may engage other orifices 116 of the goggles 106, and the coupling point of the de-misting system to the goggles 106 need not be the harness point(s). As a non-limiting example, in FIG. 1, the goggles 106 further include an optional goggles vent 120, and in such embodiments the goggles vent 120 may be another orifice engaged by the de-misting system 104.

In other embodiments, and as previously mentioned, various features may be removed and/or included as desired compared to the mask 102 depending on the type of mask system. As a non-limiting, in one embodiment, the harness 108 may be omitted and/or the mask portion 110 may be omitted.

As illustrated in FIG. 1, the de-misting system 104 includes a supply connector 122, a de-mist tube 124, and a diffuser 126. Optionally, the de-misting system 104 may include a vent 128. In some embodiments, the de-misting system 104 may be provided as a retrofitting system for the mask 102; however, in other embodiments, the de-misting system 104 may be provided natively with the mask system 100.

The supply connector 122 is connectable to an existing source of a de-misting gas. As mentioned, in some embodiments, the de-misting gas may be a dry gas, and the supply connector 122 may be connectable to a source of the dry gas, including but not limited to a compressed source, a canister or tank, a delivery hose, combinations thereof, and/or other sources as desired. The supply connector 122 may have various shapes, configurations, and/or features as desired suitable for connecting to the source of the de-misting gas. Optionally, the supply connector 122 may have various features for controlling the amount or rate of the de-misting gas to the demising system 104, including but not limited to various vents, valves, etc. as desired. In the embodiment illustrated, the supply connector 122 is connected to the breathing hose 112, and the dc-misting gas is the same as the breathing gas provided to the user. In other embodiments, the de-misting gas may be separately provided from the breathing gas, and the de-misting gas need not be breathing gas in other embodiments.

The diffuser 126 is coupled to the goggles 106, and the de-mist tube 124 fluidly connects the supply connector 122 with the diffuser 126 such that the de-misting gas can be supplied from the supply connector 122 to the diffuser 126. The de-mist tube 124 may be various suitable types of conduit for fluidly connecting the supply connector 122 with the diffuser 126, and the specific de-mist tube 124 illustrated in FIG. 1 should not be considered limiting.

In various embodiments, the diffuser 126 is coupled to the goggles such that diffuser 126 is in fluid communication with the interior volume of the goggles 106 and/or the diffuse 126 may supply the de-misting gas to the interior volume of the goggles 106. In certain embodiments, the diffuser 126 is coupled to one of the orifices 116, and in the embodiment illustrated, the diffuser 126 is coupled to the orifice 116A such that the de-misting gas can be obtained from the source and routed to the interior volume of the goggles 106.

In some embodiments, the diffuser 126 optionally includes various features for supplying the de-misting gas to the interior volume of the goggles 106 with a laminar flow across the interior surface 146 of the lens 114 of the goggles 106. Such features may include, but are not limited to, grille features, ducts, fins, slats. etc. as desired. In other embodiments, the flow of the de-misting gas provided by the diffuser 126 need not be perfectly laminar, and the de-misting gas may flow with some turbulence. In certain embodiments, the diffuser 126 may include various features to minimize or reduce the amount of turbulence of flow of the de-misting gas within the interior volume of the goggles 106 and/or across the surface of the lens 114. In some embodiments, the diffuser 126 includes features such that a desired area of the lens 114 is de-misted with the de-misting gas. As a non-limiting example, the diffuser 126 may include features that direct the de-misting gas into the interior volume of the goggles 106 such that at least a portion of the lens 114 corresponding to eye level of the user is de-misted. In other embodiments, the diffuser 126 may direct the de-misted gas into the interior volume such that the entire interior surface 146 of the lens 114 is de-misted. As such, the desired area may be the entire interior surface 146 of the lens 114 or less than the entire interior surface 146 (e.g., not including areas where visual acuity is less important).

Optionally, the diffuser 126 may include various features for controlling the flow of the de-misting gas into the interior volume of the lens 114. Such features may include, but are not limited to, valves, vents, ports, etc. as desired. In certain embodiments, the diffuser 126 includes a check valve or other suitable feature such that the flow of de-misting gas is one way through the diffuser 126. As a non-limiting example, the diffuser 126 may include a check valve that may prevent a flow of moisture and/or gas from the interior volume of the goggles 106 into the de-mist tube 124 and/or the supply connector 122.

As mentioned, in some embodiments, the de-misting system 104 optionally includes the vent 128, which may be provided for exhausting used de-misting gas from the interior volume of the goggles 106. In other embodiments, the vent 128 may be omitted, and the de-misting gas may be exhausted from the goggles 106 as desired and/or using other features of the goggles 106. As one non-limiting example, the vent 128 may be omitted, and the used de-misting gas may be exhausted via the goggles vent 120.

When included, the vent 128 may be coupled to the goggles 106 such that the vent 128 is in fluid communication with the interior volume. In some embodiments, the vent 128 is coupled to an orifice opposite the orifice 116A, and the de-misting gas is provided from the diffuser 126, into the interior volume of the goggles 106 and across at least the desired area on the lens 114, and out the vent 128. In the embodiment illustrated, the vent 128 is provided on a portion of the goggles 106 directly opposite form the diffuser 126; however, in other embodiments the vent 128 may be provided at other locations on the goggles 106 and/or relative to the diffuser 126 as desired. In certain embodiments, the vent 128 may diffuse and/or otherwise redirect a flow of the de-misting gas so as not to interfere with the user. Optionally, the vent 128 may direct the de-misting gas exhausted from the goggles 106 in a direction away from the lens 114.

Optionally. and similar to the diffuser 126, when the vent 128 is included, it may include various features for controlling the flow of the de-misting gas out of the interior volume of the lens 114. Such features may include, but are not limited to, valves, fins, ports, etc. as desired. In certain embodiments, the vent 128 includes a check valve or other suitable feature such that the flow of de-misting gas is one way through the vent 128. As a non-limiting example, the vent 128 may include a check valve that may prevent a flow of external air, smoke, and/or undesirable fluid into the goggles 106 via the vent 128. In some optional embodiments, the diffuser 126 and the vent 128 may both include check valves or other suitable features, which may maximize the flow and/or effectiveness of the de-misting gas to the goggles 106.

In certain optional embodiments, the de-misting system 104 includes one or more plugs 132 that may plug other orifices and/or openings into the interior volume of the goggles 106. In such embodiments, the diffuser 126, the optional plug(s) 132, and optional vent 128 may maximize the flow and effectiveness of the de-misting gas to de-mist the lens 114 of the goggles 106. In the embodiment illustrated, the mask portion 110 of the mask 102 includes an oral-nasal vent 134 that otherwise allows a breathing gas to move from the mask portion 110 to the interior volume of the goggles 106. In such cases, a positive pressure of breathing gas may be used to prevent smoke or other undesirable fluid from entering the interior volume of the goggles 106 when the mask 102 is otherwise used. However, the gas that enters the interior volume from the oral-nasal cavity of the mask portion 110 via the oral-nasal vent 134 may be laden with condensation because of the user's exhalation. As such, this gas is often a source of vapor that condenses on the lens. In this embodiment, when the de-misting system 104 is used by the user, a plug 132 may be positioned in the vent 134 to obstruct the flow of gas or fluid into the interior volume of the goggles 106. The disclosure of the oral-nasal vent 134 should not be considered limiting, and as mentioned, in other embodiments, a mask 102 need not include such a vent. Additionally or alternatively, the plug(s) 132 may be used to block other openings and/or potential access points into the interior volume of the goggles 106 to minimize and/or prevent unwanted gas from entering the interior volume of the goggles 106.

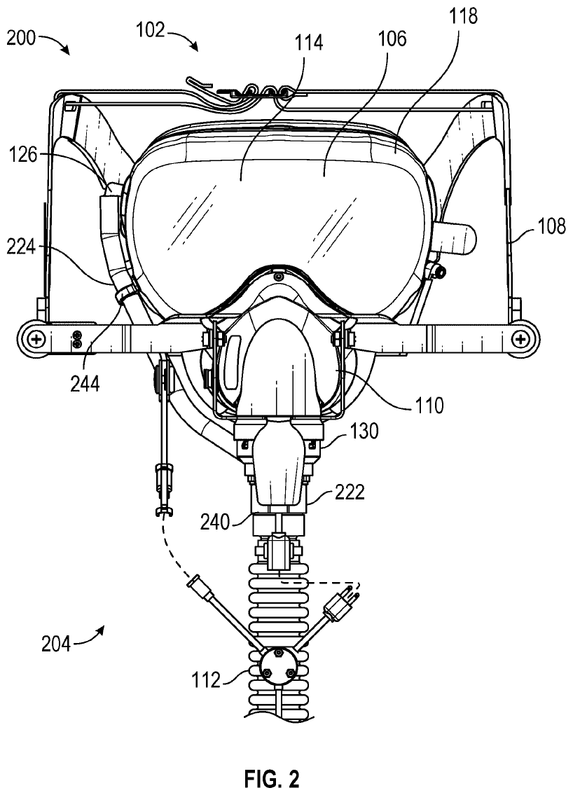

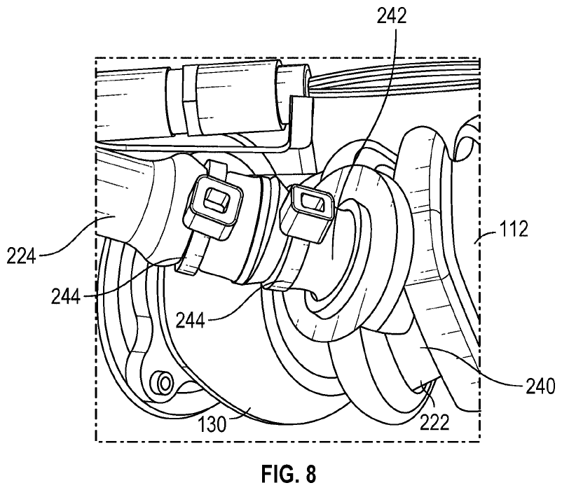

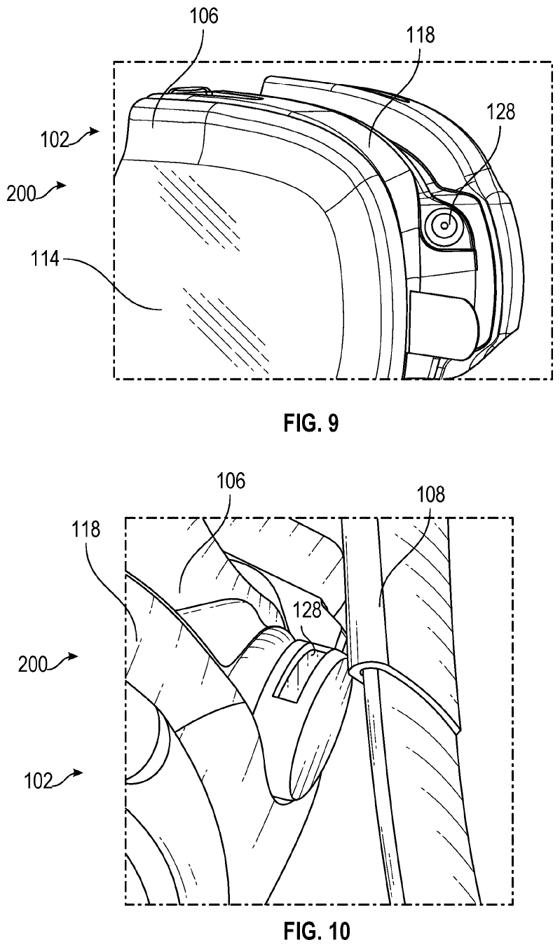

FIGS. 2-10 illustrate another example of a mask system 200 with the mask 102 and a de-misting system 204 according to various embodiments. The de-misting system 204 is similar to the de-misting system 104 and includes a supply connector 222, a de-mist tube 224, and the diffuser 126. Similar to the de-misting system 104, the de-misting system 204 provides a de-misting gas from a gas source, such as the breathing hose 112, to the interior volume of the goggles 106 to de-mist the lens 114 of the goggles 106.

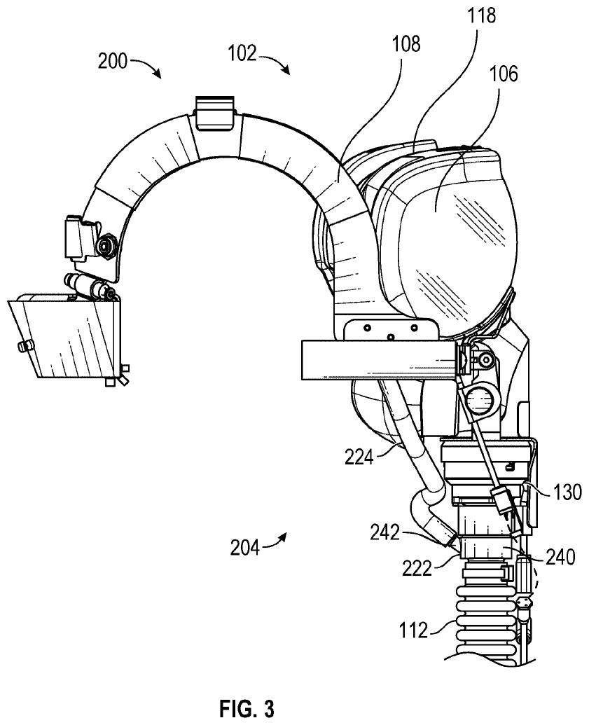

Compared to the supply connector 122, and as best illustrated in FIGS. 3 and 5, the supply connector 222 is a tee-connector that defines a main portion 240 having a main passage and a branch portion 242 having a branch passage. In various embodiments, the main portion 240 includes a first end 246 and a second end 248 opposite the first end 246. The branch portion 242 optionally extends from the main portion 240 between the first end 246 and the second end 248. In some embodiments, the branch portion 242 extends from the main portion 240 at an oblique angle, although in other embodiments the angle between the branch portion 242 and the main portion 240 need not be oblique. In some cases, at least one characteristic of the branch portion 242 is different from the main portion 240, although it need not be in other embodiments. In the example illustrated, a length and diameter of the branch portion 242 is less than a length and diameter of the main portion 240. In the embodiment where the supply connector 222 is the tee-connector, the main portion 240 may be connected to the mask portion 110 and/or the breathing hose 112, optionally in-line with the breathing hose 112, and optionally between the breathing hose 112 and the flow regulator 130. Optionally, the first end 246 of the main portion 240 may be coupled with the flow regulator 130 and the second end 248 may be coupled to the breathing hose 112, although they need not be in other embodiments. The branch portion 242 may be connected to the de-misting tube 224 such that a portion of the flow of the breathing gas between the breathing hose 112 and the flow regulator 130 is diverted to the de-mist tube 224. The disclosure of the supply connector 222 as a tee-connector should not be considered limiting, and in other embodiments, the supply connectors of de-misting systems provided herein may be other types of connectors as desired.

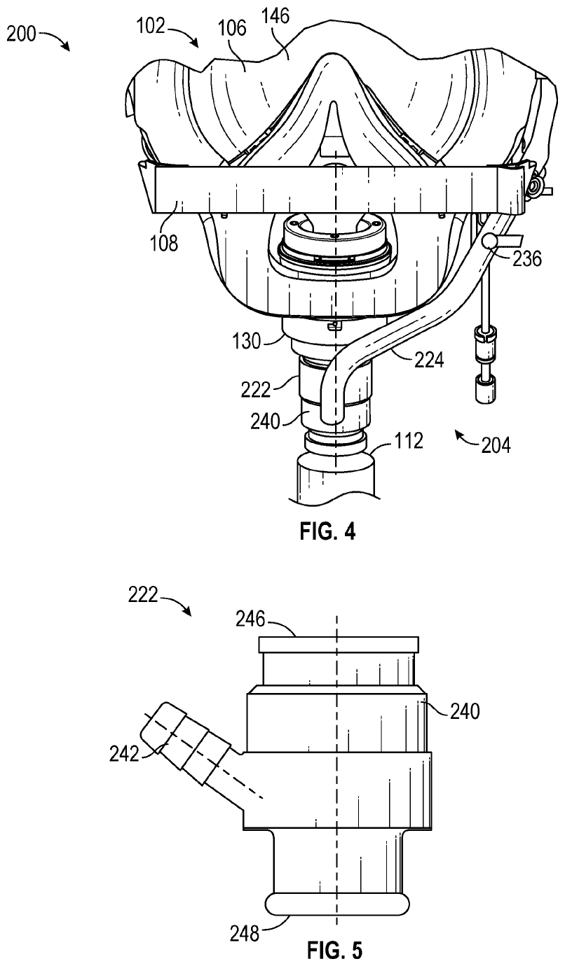

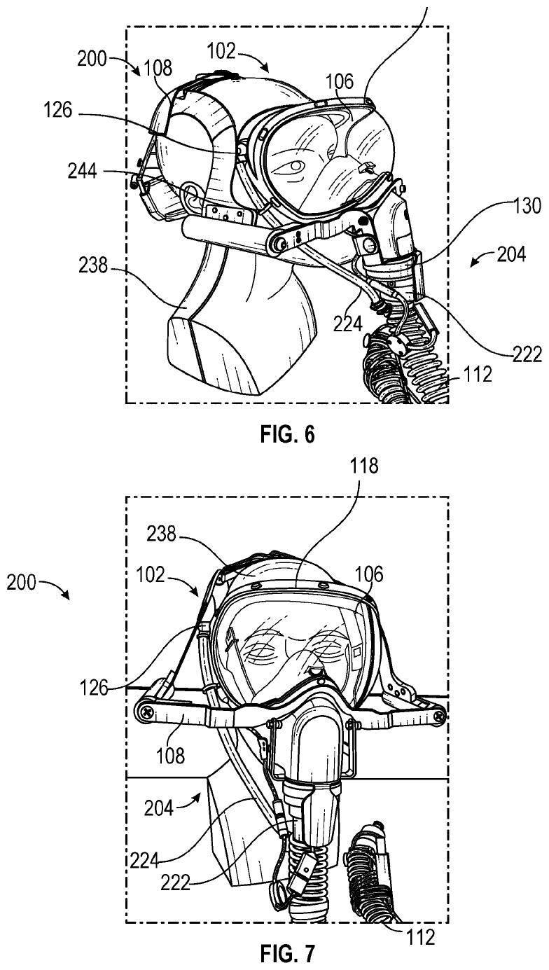

The de-mist tube 224 is similar to the de-mist tube 124 except that the de-mist tube 224 further includes a control valve 236 (see FIG. 4) that can be used by a user 238 (see FIGS. 5 and 6) to selectively stop and start a flow of the de-misting gas from the supply connector 222 to the diffuser 226. In this embodiment, the user 238 of the mask system 200 may stop the flow of the de-misting gas when de-misting is not needed in order to conserve the de-misting gas, particularly if the de-misting gas is the breathing gas. In another non-limiting example, the user 238 may stop a flow of gas through the de-mist tube 224 for leak testing the mask 102.

Compared to the de-misting system 104, the de-misting system 204 includes one or more positioners 244 for positioning and/or attaching the components of the de-misting system 204 together and/or relative to components of the mask 102. In some embodiments, the positioners 244 may attach the components of the de-misting system 204 to the mask 102 to minimize potential interference with the mobility, visibility, etc. of the user 238. In the embodiment illustrated, the positioners 244 are retention clips or bands, although other suitable features or components may be used as desired.

A method of attaching the de-misting system 204 to the goggles 106 includes attaching the supply connector 222 to the breathing hose 112 or other suitable de-misting gas source attaching the diffuser 126 to an orifice 116 of the goggles 106, including but not limited to a harness point of the goggles, and attaching the de-mist tube 224 to the supply connector 222 and the diffuser 126. In some embodiments, the method optionally includes supplying the de-misting gas to the interior volume of the goggles 106 and such that the diffuser 126 causes a generally laminar flow of the de-misting gas across the interior surface 146 of the lens 114 of the goggles 106. Optionally, the method includes attaching the plug 132 to the oral-nasal vent 134 of the goggles 106. Optionally, the method includes attaching the vent 128 to a second orifice 116 of the goggles 106, and optionally an orifice 116 that is opposite from the diffuser 126. The method may optionally include exhausting used de-misting gas from the interior volume of the goggles 106 via the vent 128.

In some embodiments, the de-misting systems provided herein may be advantageous in that they utilize existing oxygen or air flow, such as to the mask, to provide active anti-fogging/de-misting and to prevent accumulation of condensation on the lens of goggles, which would otherwise affect the clarity/visual acuity of the lens, and goggles. In various embodiments, the de-misting systems provided herein may additionally or alternatively allow for control of the delivery flow and/or pressure of the de-misting gas to the goggles in a way that minimizes or limits the flow of the de-misting gas while direct it across the interior surface of the lens of the goggles for optimal results. Venting valves can be used to remove the exhaust gas (gas that has picked-up moisture away from the lens, optics, etc.) from the mask, respirator, helmet, etc. The de-misting systems described herein may also advantageously provide the use of dry, breathing gas routed from the gas supply directly to the goggles for the purpose of anti-fogging, deviating, and removal/prevention of condensation on the lens. In various embodiments, the de-misting systems described herein may include a diffuser that directs the flow of the de-misting gas across the lens and out a vent valve. In certain embodiments, the de-misting systems may advantageously include a de-mist tube with a controller, such as a valve, to allow the user to turn on and turn off the de-mist capability for mask leakage testing and/or oxygen conservation when the de-misting feature is not required. In some embodiments, the de-misting systems may provide de-misting by utilizing de-misting (breathable) gas from a pilot oxygen mask supply to a helmet visor. In various embodiments, the de-misting systems provided herein may be used in various mask systems as desired, including but not limited to commercial and military oxygen masks, respirators and CBRN systems that utilize dry/pressurized gas for the purpose of actively anti fogging or prevention of the accumulation of condensation on google/respirator lenses. In some embodiments, the de-misting systems provided herein advantageously include a backflow check valve to minimize or prevent smoke or toxic fumes from traveling back into the gas supply.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A de-misting system for goggles, the de-misting system comprising: a supply connector connectable to a de-misting gas source; a de-mist tube in fluid communication with the supply connector, and a diffuser in fluid communication with the de-mist tube, wherein the diffuser is configured to couple to an orifice of the goggles to supply a de-misting gas to an interior volume of the goggles.

Illustration 2. The de-misting system of any preceding or subsequent illustrations or combination of illustrations, wherein the diffuser is configured to couple to a harness point of the goggles.

Illustration 3. The de-misting system of any preceding or subsequent illustrations or combination of illustrations, wherein the diffuser is configured to supply the de-misting gas with a laminar flow across an interior surface of the goggles.

Illustration 4. The de-misting system of any preceding or subsequent illustrations or combination of illustrations, further comprising a vent for exhausting the de-misting gas from the interior volume of the goggles, wherein the vent is configured to couple to a second orifice of the goggles.

Illustration 5. The de-misting system of any preceding or subsequent illustrations or combination of illustrations, wherein the vent is configured to couple to a second harness point of the goggles opposite from a first harness point of the goggles.

Illustration 6. The de-misting system of any preceding or subsequent illustrations or combination of illustrations, wherein the vent further comprises a check valve.

Illustration 7. The de-misting system of any preceding or subsequent illustrations or combination of illustrations, wherein the diffuser further comprises a check valve.

Illustration 8. The de-misting system of any preceding or subsequent illustrations or combination of illustrations, wherein the de-mist tube further comprises a control valve for controlling a flow of the de-misting gas from the gas source to the diffuser.

Illustration 9. The de-misting system of any preceding or subsequent illustrations or combination of illustrations, further comprising an intra-mask plug configured to block an oral-nasal vent of the goggles.

Illustration 10. The de-misting system of any preceding or subsequent illustrations or combination of illustrations, wherein the supply connector comprises a tee connector comprising a main passage and a branch passage, and wherein the de-mist tube is attached to the branch passage of the supply connector.

Illustration 11. A mask system comprising: goggles comprising a lens defining an interior volume and an orifice providing access to the interior volume; and the de-misting system of claim 1, wherein the diffuser is coupled to the orifice of the goggles.

Illustration 12. The mask system of any preceding or subsequent illustrations or combination of illustrations, wherein the orifice is a first harness point, wherein the goggles further comprise a second harness point, and wherein the de-misting system further comprises a vent coupled to the second harness point for exhausting the de-misting gas from the interior volume of the goggles.

Illustration 13. The mask system of any preceding or subsequent illustrations or combination of illustrations, further comprising a mask portion for receiving a breathing gas.

Illustration 14. The mask system of any preceding or subsequent illustrations or combination of illustrations, further comprising a breathing hose connected to the mask portion and configured to supply the breathing gas to the mask system, wherein the supply connector is connected to the breathing hose such that the breathing gas is supplied to the diffuser and the goggles as the de-misting gas.

Illustration 15. The mask system of any preceding or subsequent illustrations or combination of illustrations, further comprising an oral-nasal vent between the mask portion and the goggles, and wherein the de-misting system further comprises an intra-mask plug configured to the an oral-nasal vent.

Illustration 16. A mask system comprising: goggles comprising a lens defining an interior volume and an orifice providing access to the interior volume; and a de-misting system in fluid communication with the orifice, wherein the de-misting system is configured to supply a de-misting gas from a gas source to the interior volume of the goggles via the orifice.

Illustration 17 The mask system of any preceding or subsequent illustrations or combination of illustrations, wherein the de-misting system comprises: a supply connector; a diffuser attached to the orifice; and a de-mist tube connecting the supply connector with the diffuser.

Illustration 18. The mask system of any preceding or subsequent illustrations or combination of illustrations, further comprising: a mask portion; and a breathing hose connected to the mask portion and configured to supply a breathing gas to the mask portion, wherein the supply connector is connected to the breathing hose such that at least some of the breathing gas is supplied to the interior volume as the de-misting gas.

Illustration 19. The mask system of any preceding or subsequent illustrations or combination of illustrations, wherein the mask system is selected from the group consisting of an oxygen mask, a smoke mask, a respirator, a chemical, biological, radiological, and nuclear (CBRN) respirator, a fire-fighting mask, a scuba system, a helmet optic, a corrective lens, or night-vision goggles.

Illustration 20. A method for attaching a de-misting system to existing goggles, comprising: attaching a supply connector to a breathing hose; attaching a diffuser to a first harness point of the goggles; and attaching a de-mist tube to the supply connector and the diffuser.

Illustration 21. A de-misting system for attachment to existing goggles, the de-misting system comprising: a supply connector for supplying de-misting gas, the supply connector being configured to connect to a gas source; a de-mist tube in fluid communication with the supply connector; and a diffuser in fluid communication with the de-mist tube and configured to couple to a first harness point of the existing goggles to supply de-mist gas to an interior of the goggles.

Illustration 22. The system of any preceding or subsequent illustrations or combination of illustrations, wherein the diffuser is configured to cause a generally laminar flow of de-misting gas across an interior surface of a lens of the goggles.

Illustration 23. The system of any preceding or subsequent illustrations or combination of illustrations, further comprising an intra-mask plug configured to block an oral-nasal vent of the goggles.

Illustration 24. The system of any preceding or subsequent illustrations or combination of illustrations, further comprising a vent for exhausting de-misting gas from the interior of the goggles, wherein the vent is configured to be coupled to a second harness point of the goggles.

Illustration 25. The system of any preceding or subsequent illustrations or combination of illustrations, wherein the diffuser further comprises a check valve.

Illustration 26. The system of any preceding or subsequent illustrations or combination of illustrations, wherein the gas source is a breathing hose.

Illustration 27 The system of any preceding or subsequent illustrations or combination of illustrations, wherein the diffuser further comprises a check valve.

Illustration 28. The system of any preceding or subsequent illustrations or combination of illustrations, wherein the de-mist tube includes a valve for selectively stopping and starting a flow of de-misting gas.

Illustration 29. A method for attaching a de-misting system to existing goggles, comprising: attaching a supply connector to a breathing hose; attaching a diffuser to a first harness point of the goggles; attaching a de-mist tube to the supply connector and the diffuser.

Illustration 30. The method of any preceding or subsequent illustrations or combination of illustrations, wherein the diffuser is configured to cause a generally laminar flow of de-misting gas across an interior surface of a lens of the goggles.

Illustration 31. The method of any preceding or subsequent illustrations or combination of illustrations, further comprising attaching an intra-mask plug into an oral-nasal vent of the goggles.

Illustration 32. The method of any preceding or subsequent illustrations or combination of illustrations, further comprising attaching a vent to a second harness point of the goggles for exhausting de-misting gas from the interior of the goggles.

Illustration 33. The method of any preceding or subsequent illustrations or combination of illustrations, wherein the gas source is a breathing hose.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A de-misting system for goggles, the de-misting system comprising:
a supply connector connectable to a do-misting gas source;
a de-mist tube in fluid communication with the supply connector; and
a diffuser in fluid communication with the de-mist tube, wherein the diffuser is configured to couple to an orifice of the goggles to supply a de-misting gas to an interior volume of the goggles.

2. The de-misting system of claim 1, wherein the diffuser is configured to couple to a harness point of the goggles.

3. The de-misting system of claim 1, wherein the diffuser is configured to supply the de-misting gas with a laminar flow across an interior surface of the goggles.

4. The de-misting system of claim 1, further comprising a vent for exhausting the de-misting gas from the interior volume of the goggles, wherein the vent is configured to couple to a second orifice of the goggles.

5. The de-misting system of claim 4, wherein the vent is configured to couple to a second harness point of the goggles opposite from a first harness point of the goggles.

6. The de-misting system of claim 4, wherein the vent further comprises a check valve.

7. The de-misting system of claim 1, wherein the diffuser further comprises a check valve.

8. The de-misting system of claim 1, wherein the de-mist tube further comprises a control valve for controlling a flow of the de-misting gas from the gas source to the diffuser.

9. The de-misting system of claim 1, further comprising an intra-mask plug configured to block an oral-nasal vent of the goggles.

10. The de-misting system of claim 1, wherein the supply connector comprises a tee connector comprising a main passage and a branch passage, and wherein the de-mist tube is attached to the branch passage of the supply connector.

11. A mask system comprising:
goggles comprising a lens defining an interior volume and an orifice providing access to the interior volume; and
the de-misting system of claim 1, wherein the diffuser is coupled to the orifice of the goggles.

12. The mask system of claim 11, wherein the orifice is a first harness point, wherein the goggles further comprise a second harness point, and wherein the de-misting system further comprises a vent coupled to the second harness point for exhausting the de-misting gas from the interior volume of the goggles.

13. The mask system of claim 11, further comprising a mask portion for receiving a breathing gas.

14. The mask system of claim 13, further comprising a breathing hose connected to the mask portion and configured to supply the breathing gas to the mask system, wherein the supply connector is connected to the breathing hose such that the breathing gas is supplied to the diffuser and the goggles as the de-misting gas.

15. The mask system of claim 13, further comprising an oral-nasal vent between the mask portion and the goggles, and wherein the de-misting system further comprises an intra-mask plug configured to the an oral-nasal vent.

16. A mask system comprising:
goggles comprising a lens defining an interior volume and an orifice providing access to the interior volume; and
a de-misting system in fluid communication with the orifice, wherein the de-misting system is configured to supply a de-misting gas from a gas source to the interior volume of the goggles via the orifice.

17. The mask system of claim 16, wherein the de-misting system comprises:
a supply connector;
a diffuser attached to the orifice; and
a de-mist tube connecting the supply connector with the diffuser.

18. The mask system of claim 17, further comprising:
a mask portion; and
a breathing hose connected to the mask portion and configured to supply a breathing gas to the mask portion,
wherein the supply connector is connected to the breathing hose such that at least some of the breathing gas is supplied to the interior volume as the de-misting gas.

19. the mask system of claim 16, wherein the mask system is selected from the group consisting of an oxygen mask, a smoke mask, a respirator, a chemical, biological, radiological, and nuclear (CBRN) respirator, a fire-fighting mask, a scuba system, a helmet optic, a corrective lens, or night-vision goggles.

20. A method for attaching a de-misting system to existing goggles, comprising:
attaching a supply connector to a breathing hose;
attaching a diffuser to a first harness point of the goggles; and
attaching a de-mist tube to the supply connector and the diffuser.
